(19) United States
(12) Patent Application Publication
(10) Pub. No.: US 2016/0366717 A1
(43) Pub. Date: Dec. 15, 2016

(54) Signal Processing Method and Device

(71) Applicant: ZTE CORPORATION, Shenzhen, Guangdong (CN)

(72) Inventors: Jin YANG, Shenzhen City, Guangdong Province (CN); Shuanshuan WU, Shenzhen City, Guangdong Province (CN); Bo DAI, Shenzhen City, Guangdong Province (CN); Ming YUAN, Shenzhen City, Guangdong Province (CN); Wenhuan WANG, Shenzhen City, Guangdong Province (CN); Shuanghong HUANG, Shenzhen City, Guangdong Province (CN)

(21) Appl. No.: 15/118,290

(22) PCT Filed: Aug. 25, 2014
(86) PCT No.: PCT/CN2014/085125

§ 371 Date: Aug. 11, 2016

(30) Foreign Application Priority Data
Feb. 19, 2014 (CN) 201410055890.6

(51) Int. Cl. H04W 76/02; H04W 72/04; H04L 25/03

(52) U.S. Cl. CPC H04W 76/023; H04L 25/03866; H04W 72/0406; H04W 72/04

(57) ABSTRACT

A signal processing method and device, the method includes: when there are data to be sent, user equipment determining a generation mode of a pseudo-random sequence according to a type of the data to be sent; when the type of the data to be sent is device-to-device communication data, the user equipment assigning a value to an initial value for generating the pseudo-random sequence according to a predefined rule, and generating the pseudo-random sequence according to the initial value; generating one or more of a scrambling sequence, a cyclic shift sequence and a pilot sequence according to the pseudo-random sequence; and processing the data to be sent by using one or more of the scrambling sequence, the cyclic shift sequence and the pilot sequence.

### CROSS-REFERENCE TO RELATED APPLICATION(S)

This application is the U.S. National Phase application of PCT application number PCT/CN2014/085125 having a PCT filing date of Aug. 25, 2014, which claims priority to Chinese patent application 201410055890.6 filed on Feb. 19, 2014, the disclosures of which are hereby incorporated by reference.

### TECHNICAL FIELD

The present invention relates to the field of mobile communication, in particular to a signal processing method in Device-to-Device (D2D) communication.

### BACKGROUND OF RELATED ART

In a cellular system, when there are services which need to be transmitted between two User Equipment (UE), service data from user equipment 1 (UE1) to user equipment 2 (UE2) firstly are transmitted to a base station 1 through an air interface, the base station 1 transmits the user data to a base station 2 through a core network, then the base station 2 transmits the service data to the UE2 through an air interface, and service data from UE2 to UE1 are transmitted with the similar processing flow. When UE1 and UE2 are located in the same cell, as illustrated in FIG. 1, although the base station 1 and the base station 2 are the same site, two sets of radio resources will be still consumed for one piece of data transmission.

Accordingly, it shows that, if UE1 and UE2 are located in the same cell and the distance between them is comparatively short, obviously the above-mentioned cellular communication method is not the optimal communication method. In fact, with the diversification of mobile communication services, for example, applications of social network, electronic payment and the like in a radio communication system become increasingly wide, the demands of service transmission between short-range users are increasing. Therefore, a D2D communication mode is increasingly and widely concerned. D2D communication, as illustrated in FIG. 2, refers to that service data are not forwarded by a base station and are directly transmitted from source user equipment to target user equipment through an air interface. This communication mode has a feature which is obviously different from the traditional communication mode of the cellular system. For users in short-range communication, D2D transmission not only saves radio spectrum resources, but also reduces data transmission pressure of the core network. D2D communication based on a cellular network is a novel technology for direct communication between a plurality of terminal devices supporting a D2D function under the control of a system. D2D communication can reduce system resources occupation, increase spectrum efficiency of a cellular communication system, decrease terminal transmitting power consumption and reduce network operation costs to a very great extent.

In a cellular communication network, UE sends uplink signals on Physical Uplink Shared Channel (PUSCH) and Physical Uplink Control Channel (PUCCH), a pseudo-random sequence needs to be used in steps such as scrambling, cyclic shift sequence generation and pilot sequence generation and the like in signal processing of the PUSCH and PUCCH, and the pseudo-random sequence is generated through a corresponding initial value. UE can obtain identification information such as cell identification (Cell ID), Cell Radio Network Temporary Identifier (C-RNTI) of UE and the like according to configuration of a network side, and use the identification information as initialization parameters in the generation process of the pseudo-random sequence. In a D2D network, D2D UE also can use PUSCH/PUCCH to carry information and send signals. However, when the D2D UE forms a network by means of self-organization, the network has no central control node for performing scheduling configuration on resources, parameters and the like of UE. Therefore, UE cannot directly use the signal processing method in the cellular communication to perform pseudo-random sequence initialization based on Cell ID and/or C-RNTI and further perform processing such as scrambling and pilot generation and the like on signals.

### SUMMARY OF THE INVENTION

The technical problem to be solved by the present invention is to provide a signal processing method and device, such that UE can generate a pseudo-random sequence by using a predefined initial value type as an initialization parameter, and further perform processing such as scrambling, cyclic shift, pilot insertion and the like on signals to be sent based on the pseudo-random sequence, so as to play roles of randomizing the signal interference, enhancing the anti-interference capability, and improving the signal receiving correction rate and the resource utilization rate.

In order to solve the above-mentioned technical problem, the present invention provides a signal processing method, comprising:

when there are data to be sent at user equipment, the user equipment determining a generation mode of a pseudo-random sequence according to a type of the data to be sent;

when the type of the data to be sent is device-to-device communication data, the user equipment assigning a value to an initial value for generating the pseudo-random sequence according to a predefined rule, and

the user equipment generating the pseudo-random sequence according to the initial value; generating one or more of a scrambling sequence, a cyclic shift sequence and a pilot sequence according to the pseudo-random sequence; and

processing the data to be sent by using one or more of the scrambling sequence, the cyclic shift sequence and the pilot sequence.

Preferably, the method further has the following features: a value is assigned to the initial value for generating the pseudo-random sequence by using one or more of the following:

constant value, user equipment identification, group identification, frame number, subframe number, slot number, codeword number, antenna port number and resource index, wherein,

the user equipment identification is an identification number of the user equipment in a device-to-device communication network; and the group identification is an identification of a device-to-device communication group to which the user equipment belongs.

Preferably, the method further has the following features: the user equipment identification comprises:

a radio network temporary identifier, or

an international mobile equipment identity of the user equipment, or

an international mobile subscriber identification of the user equipment, or

a truncated international mobile equipment identity or a truncated international mobile subscriber identification, wherein a length of the truncated international mobile equipment identity or the truncated international mobile subscriber identification is n bits and n is a positive integer less than or equal to 16, or

an identification with length of k, wherein k is a positive integer less than 16.

Preferably, the method further has the following features: the truncated international mobile equipment identity or the truncated international mobile subscriber identification comprises:

selecting n bits from a numerical value corresponding to the international mobile equipment identity or the international mobile subscriber identification, wherein the selected n bits are continuous n bits starting from a most significant bit, or continuous n bits starting from a least significant bit, or continuous or discontinuous n bits at designated positions, or

performing a modulo-N operation on the numerical value corresponding to the international mobile equipment identity or the international mobile subscriber identification, wherein N=2ⁿ.

Preferably, the method further has the following features: the user equipment assigning a value to an initial value for generating the pseudo-random sequence according to a predefined rule comprises:

the user equipment assigning a value to the initial value for generating the pseudo-random sequence by using a fixed initial value; or

the user equipment determining to use the initial value according to one or more of the following:

attribute of a signal to be sent, target user attribute, signal sending mode, signal transmission mode, and attribute of a resource for carrying the signal.

Preferably, the method further has the following features: the user equipment assigning a value to the initial value for generating the pseudo-random sequence by using a fixed initial value comprises at least one of the following:

the user equipment assigning a value to the initial value of the pseudo-random sequence by using a constant value;

the user equipment assigning a value to the initial value of the pseudo-random sequence by using a user equipment identification;

the user equipment assigning a value to the initial value of the pseudo-random sequence by using the user equipment identification and a group identification; and

the user equipment assigning a value to the initial value of the pseudo-random sequence by using the user equipment identification and a slot number.

Preferably, the method further has the following features: the user equipment determining to use the initial value according to one or more of the following: attribute of a signal to be sent, target user attribute, signal sending mode, signal transmission mode, and attribute of the resource for carrying the signal, comprises at least one of the following:

when the attribute of the signal to be sent is control information or the attribute of the resource for carrying the signal is control channel resource, the user equipment assigning a value to the initial value of the pseudo-random sequence by using the user equipment identification and/or the constant value;

when a service type of the signal to be sent is data information or the attribute of the resource for carrying the signal is data channel resource, the user equipment assigning a value to the initial value of the pseudo-random sequence by using a user equipment identification or the group identification;

when the target user of the signal to be sent is a specific user, or the transmission mode is unicast, or the attribute of the resource for carrying the signal is unicast channel resource, the user equipment assigning a value to the initial value of the pseudo-random sequence by using a user equipment identification;

when target users of the signal to be sent are a specific group of users, or the transmission mode is multicast or the attribute of the resource for carrying the signal is multicast channel resource, the user equipment assigning a value to the initial value of the pseudo-random sequence by using a user equipment identification and/or a group identification;

when target users of the signal to be sent are all other users, or the transmission mode is broadcast or the attribute of the resource for carrying the signal is broadcast channel resource, the user equipment assigning a value to the initial value of the pseudo-random sequence by using a user equipment identification and/or a constant value;

when a single-antenna sending mode is adopted for the signal to be sent, the user equipment assigning a value to the initial value of the pseudo-random sequence by using any one or more of a constant value, a user equipment identification and a slot number; and

when a multi-antenna sending mode is adopted for the signal to be sent, the user equipment assigning a value to the initial value of the pseudo-random sequence by using a user equipment identification and/or an antenna port number.

Preferably, the method further has the following features: the user equipment generating the pseudo-random sequence according to the initial value comprises:

using the initial value for assigning a value to an initial value of an m sequence for generating the pseudo-random sequence, and assigning values to initial 31 bits of the m sequence; and

obtaining the pseudo-random sequence based on the m sequence.

Preferably, the method further has the following features: the user equipment generating the pseudo-random sequence according to the initial value comprises:

using the initial value as an initial value of a shift register; and

obtaining the pseudo-random sequence based on a characteristic equation of the m sequence determined through the shift register.

Preferably, the method further has the following features:

the user equipment generating one or more of a scrambling sequence, a cyclic shift sequence and a pilot sequence according to the pseudo-random sequence comprises:

using the pseudo-random sequence as the scrambling sequence; or

using the pseudo-random sequence as the cyclic shift sequence, or obtaining a fundamental sequence of the cyclic shift sequence according to the pseudo-random sequence; or

obtaining a fundamental sequence of the pilot sequence according to the pseudo-random sequence; and

the user equipment processing the data to be sent by using one or more of the scrambling sequence, the cyclic shift sequence and the pilot sequence comprises:

performing scrambling processing on the data to be sent by using the scrambling sequence; or

performing cyclic shift processing on the data to be sent by using the cyclic shift sequence; or

using the pilot sequence as a pilot of the sending of the data to be sent.

In order to solve the above-mentioned problem, the present invention further provides a signal processing device, comprising:

a determination module configured to, when there are data to be sent, determine a generation mode of a pseudo-random sequence according to a type of the data to be sent;

an assignment module configured to, when the type of the data to be sent is device-to-device communication data, assign a value to an initial value for generating the pseudo-random sequence according to a predefined rule;

a generation module configured to generate the pseudo-random sequence according to the initial value; and generate one or more of a scrambling sequence, a cyclic shift sequence and a pilot sequence according to the pseudo-random sequence; and

a processing module configured to process the data to be sent by using one or more of the scrambling sequence, the cyclic shift sequence and the pilot sequence.

Preferably, the device further has the following features: the assignment module is configured to assign a value to the initial value for generating the pseudo-random sequence by using one or more of the following: constant value, user equipment identification, group identification, frame number, subframe number, slot number, codeword number, antenna port number and resource index, wherein,

the user equipment identification is an identification number of the user equipment in a device-to-device communication network; and the group identification is an identification of a device-to-device communication group to which the user equipment belongs.

Preferably, the device further has the following features: the user equipment identification used for assignment the assignment module comprises:

a radio network temporary identifier, or

an international mobile equipment identity of the user equipment, or

an international mobile subscriber identification of the user equipment, or

a truncated international mobile equipment identity or a truncated international mobile subscriber identification, wherein a length of the truncated international mobile equipment identity or the truncated international mobile subscriber identification is n bits and n is a positive integer less than or equal to 16, or

an identification with a length of k, wherein k is a positive integer less than 16, and

the truncated international mobile equipment identity or the truncated international mobile subscriber identification comprises:

selecting n bits from a numerical value corresponding to the international mobile equipment identity or the international mobile subscriber identification, wherein the selected n bits are continuous n bits starting from a most significant bit, or continuous n bits starting from a least significant bit, or continuous or discontinuous n bits at designated positions, or

performing a modulo-N operation on the numerical value corresponding to the international mobile equipment identity or the international mobile subscriber identification, wherein N=2ⁿ.

Preferably, the device further has the following features: the assignment module is configured to assign a value to the initial value for generating the pseudo-random sequence by using a fixed initial value; or determine to use the initial value according to one or more of the following: attribute of a signal to be sent, target user attribute, signal sending mode, signal transmission mode, and attribute of a resource for carrying the signal.

Preferably, the device further has the following features:

the assignment module being configured to assign a value to the initial value for generating the pseudo-random sequence by using a fixed initial value, comprises at least one of the following: the user equipment assigning a value to the initial value of the pseudo-random sequence by using a constant value; the user equipment assigning a value to the initial value of the pseudo-random sequence by using a user equipment identification; the user equipment assigning a value to the initial value of the pseudo-random sequence by using a user equipment identification and a group identification; and the user equipment assigning a value to the initial value of the pseudo-random sequence by using a user equipment identification and a slot number.

Preferably, the device further has the following features:

the assignment module being configured to determine to use the initial value according to one or more of the following: attribute of a signal to be sent, target user attribute, signal sending mode, signal transmission mode, and attribute of a resource for carrying the signal, comprises at least one of the following: when the attribute of the signal to be sent is control information or the attribute of the resource for carrying the signal is control channel resource, the user equipment assigning a value to the initial value of the pseudo-random sequence by using the user equipment identification and/or the constant value; when a service type of the signal to be sent is data information or the attribute of the resource for carrying the signal is data channel resource, the user equipment assigning a value to the initial value of the pseudo-random sequence by using a user equipment identification or a group identification; when the target user of the signal to be sent is a specific user, or the transmission mode is unicast or the attribute of the resource for carrying the signal is unicast channel resource, the user equipment assigning a value to the initial value of the pseudo-random sequence by using a user equipment identification; when target users of the signal to be sent are a specific group of users, or the transmission mode is multicast or the attribute of the resource for carrying the signal is multicast channel resource, the user equipment assigning a value to the initial value of the pseudo-random sequence by using a user equipment identification and/or a group identification; when target users of the signal to be sent are all other users, or the transmission mode is broadcast or the attribute of the resource for carrying the signal is broadcast channel resource, the user equipment assigning a value to the initial value of the pseudo-random sequence by using a user equipment identification and/or a constant value; when a single-antenna sending mode is adopted for the signal to be sent, the user equipment assigning a value to the initial value of the pseudo-random sequence by using any one or more of a constant value, a user equipment identification and a slot number; and when a multi-antenna sending mode is adopted for the signal to be sent, the user equipment assigning a value to the initial value of the pseudo-random sequence by using a user equipment identification and/or an antenna port number.

Preferably, the device further has the following features:

the generation module being configured to generate the pseudo-random sequence according to the initial value, comprises: using the initial value for assigning a value to an initial value of an m sequence for generating the pseudo-random sequence, and assigning values to initial 31 bits of the m sequence; and obtaining the pseudo-random sequence based on the m sequence.

Preferably, the device further has the following features:

the generation module being configured to generate the pseudo-random sequence according to the initial value, comprises: using the initial value as an initial value of a shift register; and obtaining the pseudo-random sequence based on a characteristic equation of the m sequence determined through the shift register.

Preferably, the device further has the following features:

the generation module being configured to generate one or more of a scrambling sequence, a cyclic shift sequence and a pilot sequence according to the pseudo-random sequence, comprises: using the pseudo-random sequence as the scrambling sequence; or using the pseudo-random sequence as the cyclic shift sequence, or obtaining a fundamental sequence of the cyclic shift sequence according to the pseudo-random sequence; or obtaining a fundamental sequence of the pilot sequence according to the pseudo-random sequence; and

the processing module being configured to process the data to be sent by using one or more of the scrambling sequence, the cyclic shift sequence and the pilot sequence, comprises: performing scrambling processing on the data to be sent by using the scrambling sequence; or performing cyclic shift processing on the data to be sent by using the cyclic shift sequence; or using the pilot sequence as a pilot of the sending of the data to be sent.

In order to solve the above-mentioned problem, the present invention further provides a user equipment, comprising the above mentioned device.

To sum up, the embodiments of the present invention provide a signal processing method and device, such that UE can generate a pseudo-random sequence by using a predefined initial value type as an initialization parameter, and perform processing such as scrambling, cyclic shift, pilot insertion and the like on signals to be sent, so as to play roles of randomizing the signal interference, enhancing the anti-interference capability, and improving the signal receiving correction rate and the resource utilization rate.

### BRIEF DESCRIPTION OF THE DRAWINGS

FIG. 1 is a schematic diagram of a cellular network data communication mode in the related art;

FIG. 2 is a schematic diagram of a D2D communication mode in the related art;

FIG. 3 is a flowchart of a signal processing method according to the embodiment of the present invention;

FIG. 4 is a schematic diagram of a method for obtaining a UE ID through truncation according to the embodiment of the present invention;

FIG. 5 is a schematic diagram of another method for obtaining a UE ID through truncation according to the embodiment of the present invention;

FIG. 6 is a schematic diagram of generating a pseudo-random sequence through a shift register according to the embodiment of the present invention;

FIG. 7 is a schematic diagram of a signal processing device according to the embodiment of the present invention.

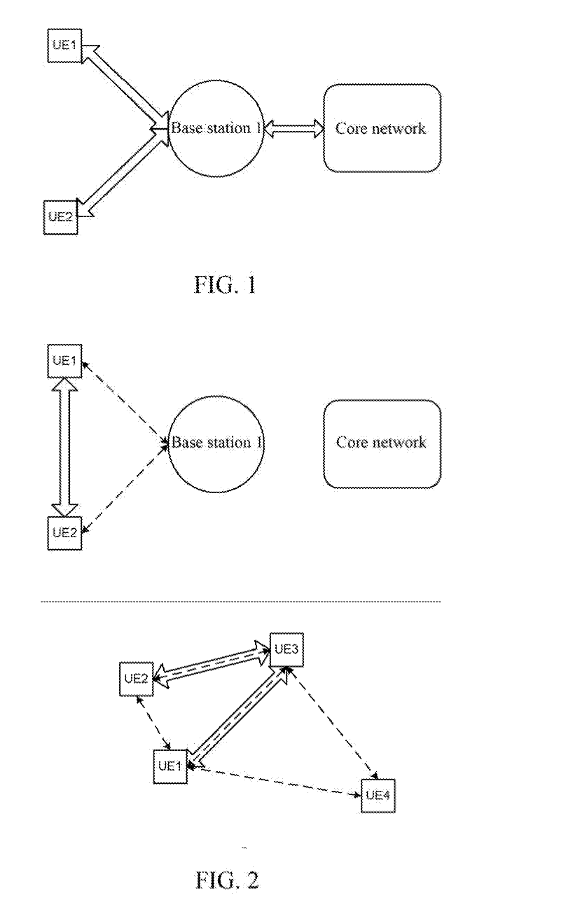

### PREFERRED EMBODIMENTS OF THE INVENTION

The embodiments of the present invention will be described below in detail in combination with the drawings. It needs to be stated that the embodiments in the present application and the features in the embodiments can be freely combined under the situation of no conflict.

In a D2D communication scenario where is out of the coverage of network, D2D UE may not depend on a central control node, a D2D communication network is formed directly by D2D UE through self-organization, and discovery and communication processes between D2D UEs are performed. In this scenario, D2D UE cannot obtain related configuration and parameters from a control node as in cellular communication and can only use basic information of D2D UE itself such as UE ID, group ID, synchronization information and timing parameter information and the like. Further, during processing of signal sending of D2D UE, processing such as scrambling, cyclic shift expansion of frequency domain and/or time domain or pilot mapping or the like needs to be performed on data to be sent, initialization assignment of a pseudo-random sequence needed in the processing should be implemented based on information that can be obtained by UE, thus replacing a processing of initialization assignment which is performed by using a Cell ID or UE C-RNTI configured at a network side in cellular communication.

The technical solution of the present invention will be further described below in combination with the drawings and the specific embodiments.

### Embodiment 1

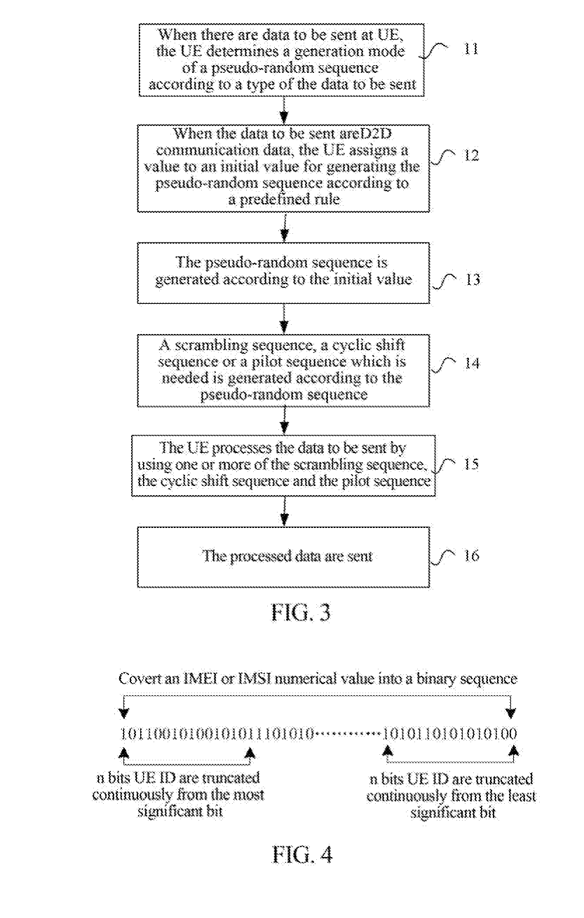

FIG. 3 illustrates a flowchart of a signal processing method provided by this embodiment. The signal processing method comprises the following steps:

In step 11, when there are data to be sent at UE, the UE determines a generation mode of a pseudo-random sequence according to a type of the data to be sent;

the type of the data is D2D communication data or cellular communication data.

In step 12, when the data to be sent is D2D communication data, the UE assigns a value to an initial value for generating the pseudo-random sequence according to a predefined rule.

The UE determines the type of the initial value of the pseudo-random sequence, such as UE ID or Group ID or the like, according to the predefined rule.

When the type of the data to be sent is cellular communication data, the UE processes the data according to a standard rule of cellular communication.

In step 13, the pseudo-random sequence is generated according to the initial value.

In step 14, one or more of a scrambling sequence, a cyclic shift sequence and a pilot sequence, which is needed, is generated according to the pseudo-random sequence.

In step 15, the UE processes the data to be sent by using one or more of the scrambling sequence, the cyclic shift sequence and the pilot sequence.

Specifically, the UE performs scrambling on the data to be sent by using the scrambling sequence, or performs cyclic shift expansion on the data to be sent by using the above-mentioned cyclic shift sequence or performs pilot mapping on the data to be sent by using the pilot sequence.

In step 16, the processed data are sent and the process ends.

From one implementation process of this embodiment, it can be seen that, when the data to be sent by the UE are D2D communication data, the UE cannot use the data processing of cellular communication to process D2D data to be sent. Thus, this embodiment provides a method, wherein, according to a predefined rule, the UE can use a fixed initial value or use a constant value, a UE ID, a Group ID, a frame number, a subframe number, a slot number, a codeword number, an antenna port number and the like as an initial value of a pseudo-random sequence according to factors such as a service type, a target user attribute, a signal sending mode and a signal transmission mode of a signal to be sent to generate the pseudo-random sequence, and further use the pseudo-random sequence for data processing such as scrambling, time domain/frequency domain cyclic shift expansion or pilot mapping or the like, such that the UE can effectively perform physical layer processing and send the D2D communication data, thereby improving interference randomization of D2D communication signal sending, improving the anti-interference capability of the signal and improving the receiving correction rate of the signal and the system resource utilization rate.

The frame number, subframe number and slot number which may be used as the initial value can be determined according to system timing based on which the UE sends the signal in the D2D communication system. According to the specification of the D2D communication system, in a time domain, a system resource is divided into frames, subframes and slots which are correspondingly numbered according to the order, and thus the frame number, the subframe number and the slot number are uniform numbers which are known by all D2D UE. Codeword refers to a basic unit in processing such as coding performed by the UE on data and the like in a data processing, the codeword is also correspondingly numbered and the number is recorded as codeword number q. An antenna port refers to a single-antenna or multi-antenna port which may be adopted by the UE during signal sending, and thus there is an antenna port serial number which is recorded as p. Resource index refers to an index number of a resource for carrying D2D communication data when the UE sends the D2D communication data, and is specifically the smallest index number of the used Physical Resource Block (PRB) or the used channel index number.

In step 12, when there are the D2D communication data to be sent at UE, the UE assigns a value to the initial value for generating the pseudo-random sequence according to the predefined rule, wherein the predefined rule in this embodiment may be:

the UE uses a fixed initial value, for example, the UE assigns a value to the initial value of the pseudo-random sequence by using the constant value; the UE assigns a value to the initial value of the pseudo-random sequence by using the UE ID; the UE assigns a value to the initial value of the pseudo-random sequence by using the UE ID and the Group ID; the UE assigns a value to the initial value of the pseudo-random sequence by using the UE ID and the slot number, etc.;

or the UE determines a type of an initial value needed by generating a corresponding pseudo-random sequence according to one or more of the factors such as attribute of signal to be send, target user attribute, signal sending mode, signal transmission mode, and attribute of a resource for carrying the signal and the like.

Here, the type of the signal to be sent comprises service attribute of the signal such as VoIP service, data service or streaming media service or type attribute of the signal such as control information or data information or the like;

the target user attribute comprises that the target user is a specific user, or a group of users or all users, etc;

the signal transmission mode comprises unicast, broadcast, multicast, multicast, etc;

the signal sending mode comprises single-antenna sending, multi-antenna sending, etc.; and

the attribute of the resource for carrying the signal comprises control channel resource, data channel resource, broadcast channel resource, multicast channel resource, unicast channel resource, etc.

The UE may select a corresponding initial value assignment mode based on the above-mentioned factors during signal sending according to the predefined rule. For example,

when the attribute of the signal to be sent is control information or the attribute of the resource for carrying the signal is control channel resource, the UE assigns a value to the initial value of the pseudo-random sequence by using the UE ID and/or the constant value;

when the attribute of the signal to be sent is data service or the attribute of the resource for carrying the signal is data channel resource, the UE assigns a value to the initial value of the pseudo-random sequence by using the UE ID or the Group ID;

when a target user of the signal to be sent is a specific user, or a transmission mode is unicast or the attribute of the resource for carrying the signal is unicast channel resource, the UE assigns a value to the initial value of the pseudo-random sequence by using the UE ID;

when target users of the signal to be sent are a specific group of users, or the transmission mode is multicast or the attribute of the resource for carrying the signal is multicast channel resource, the UE assigns a value to the initial value of the pseudo-random sequence by using the UE ID and/or the Group ID;

when target users of the signal to be sent are all other users, or the transmission mode is broadcast or the attribute of the resource for carrying the signal is broadcast channel resource, the UE assigns a value to the initial value of the pseudo-random sequence by using the UE ID and/or the constant value;

when a single-antenna sending mode is adopted for the signal to be sent, the UE assigns a value to the initial value of the pseudo-random sequence by using the constant value and/or the UE ID and/or the slot number; and

when a multi-antenna sending mode is adopted for the signal to be sent, the UE assigns a value to the initial value of the pseudo-random sequence by using the UE ID and/or the antenna port number.

The pseudo-random sequence described here may be generated according to different generation modes.

Mode 1:

An m sequence is used as the pseudo-random sequence, the initial value is an initial value of a corresponding shift register, and based on a determined characteristic equation of the m sequence, if the initial value is given, the corresponding pseudo-random sequence can be obtained.

Mode 2:

A pseudo-random sequence c(i) is generated through a Gold sequence with the length of 31:

c(n)=(x₁(n+N_{C})+x₂(n+N_{C}))mod 2

x₁(n+31)=(x₁(n+3)+x₁(n))mod 2

x₂(n+31)=(x₂(n+3)+x₂(n+2)+x₂(n+1)+x₂(n))mod 2

wherein, N_{C}=1600, the two m sequences are respectively recorded as x₁(n) and x₂(n)

initial values of first 31 bits of x₁ (n) sequence are: x₁(0)=1, x₁(n)=0, n=1, 2, . . . , 30,

initial values cᵢₙᵢₜ of first 31 bits of x₂(n) sequence may be assigned according to the above-mentioned various types of initial values, an expression is, cᵢₙᵢₜ=Σᵢ₌₀³⁰x₂(i)·2ⁱ, and according to the predefined rule, the rule of assigning a fixed initial value to cᵢₙᵢₜ is different from the rule of assigning corresponding initial values to cᵢₙᵢₜ according to different specific application scenarios, and assignment can be performed on the same cᵢₙᵢₜ by adopting one or more types of initial values.

After assignment is performed on the m sequence x₂(n) by adopting corresponding initial values, the pseudo-random sequence can be obtained based on x₁(n) and x₂ (n). Further, a corresponding scrambling sequence or a cyclic shift sequence or a pilot sequence can be generated, processing such as scrambling, time domain or frequency domain cyclic shift processing and pilot mapping and the like is performed on the signal to be sent.

### Embodiment 2

In this embodiment, types of pseudo-random sequence initial values which may be used by UE comprise constant value, UE ID, Group ID, frame number, subframe number, codeword number, antenna port number, resource index, etc. The UE may use one or more of the types as an initial value for generating a pseudo-random sequence, wherein:

the constant value refers to a fixed numerical value defined by a system, the length is h bits when the constant value is represented in binary, 1≦h≦16, a value range of corresponding decimal numerical values is [0, 2^{h}−1], and a process of obtaining ID is not needed.

Group ID is determined by a high layer or is obtained through a group common control message when the UE joins in the group, the length is t bits when the Group ID is represented in binary, 1≦t≦16, and a value range of corresponding decimal numerical values is [0, 2^{t}−1]. Group ID is identification information of the D2D communication group to which the UE belongs, and UEs which belong to the same group share the same Group ID.

UE ID is identification information for distinguishing the UE from another UE in a network, and obtaining ways of the UE ID may be different according to different ID formats.

If an RNTI format is adopted, the length is 16 bits when the UE ID is represented in binary, and a value range of corresponding decimal numerical values is [0, 2¹⁶−1]. The UE selects an unoccupied RNTI resource through listening or randomly selects an RNTI resource. For example, the UE may obtain RNTI used by surrounding other UEs by listening discovery signals or synchronizing signals or broadcast signals of surrounding other UEs and selects an RNTI different from the RNTI used by surrounding other UEs from all available RNTI resources as its own UE ID, or the UE randomly selects one RNTI from the available RNTI as its own UE ID;

if an IMEI (International Mobile Equipment Identity) or IMSI (International Mobile Subscriber Identification) format is adopted as a format of a UE ID, the UE may directly obtain IMEI and IMSI from local machine information, the length is 15 digits of decimal numbers, and when IMEI or IMSI is used as the UE ID, it should be converted into a binary bit form; or a truncated IMEI or IMSI needs to be used, a valid UE ID is obtained according to a truncating rule, the length is n bits and 1≦n≦16; and

if other formats of UE ID are adopted, for an ID with the length of k which is a positive integer less than 16, the ID obtaining way is the same as the one when the RNTI format is used.

### Embodiment 3

When UE adopts IMEI or IMSI truncating ways to obtain a UE ID, the truncating ways comprise two ways:

In way 1, a numerical value corresponding to IMEI or IMSI is represented in a binary form, continuous n bits are taken from the most significant bit or the least significant bit to use as a UE ID, as shown in FIG. 4, and thus the truncated UE ID is obtained;

or n bits are extracted from designated positions according to a certain rule to use as a UE ID, as shown in FIG. 5, and thus the truncated UE ID is obtained.

In way 2, a modulo-N operation is performed on a numerical value R corresponding to IMEI or IMSI to obtain a UE ID, i.e., UE ID=R mod N, wherein N=2ⁿ.

### Embodiment 4

In this embodiment, as predefined by a system, in a process that UE performs scrambling processing on a signal by adopting a constant value during processing of the signal to be sent, an initial value of a scrambling sequence is generated, and D2D ID used is 9 bits, e.g., “101000100”, the UE performs initialization on a pseudo-random sequence to generate the pseudo-random sequence by using the D2D ID and performs scrambling processing on data by using the pseudo-random sequence as the scrambling sequence.

Or, further, a corresponding constant value may be predefined and used as an initial value of a scrambling sequence according to an attribute of a signal to be sent, a target user attribute, a signal sending mode of a signal to be sent and an attribute of a resource for carrying the signal. For example, for a control channel, “1010 0010 0111” is fixedly used as an initial value, for a data channel, “1110 0100 1001” is fixedly used as an initial value, or, for a broadcast channel, a constant value is fixedly used as an initial value, for a unicast channel, a constant value is fixedly used as an initial value, etc.

Using the constant value as an initial value for generating the pseudo-random sequence has the advantage of simplicity and easiness in implementation. Especially, in a D2D communication network in a non-covered scenario, since there is no main control node and D2D UE cannot obtain related parameter configuration instructions from the control node, the initialization of the pseudo-random sequence needed in the data processing performed by the D2D UE can be implemented in the simplest way by directly using the fixed constant value, and simple and high-efficiency D2D data signal processing can be implemented.

### Embodiment 5

As predefined by a system, D2D UE may determine a type of an initial value used in a corresponding signal processing according to a service type of a signal to be sent. For example,

when the signal to be sent carries control information, a constant value is used as an initial value for generating a scrambling sequence, such initial value selection way can allow that other D2D UEs around the sending UE may receive the control information without other information, further processing may be performed according to the obtained control information, it is beneficial to improve the data receiving efficiency in a D2D communication network; and

when the signal to be sent carries service information, a UE ID is used as an initial value for generating a scrambling sequence, thus the data transmission security of D2D UE can be improved, other D2D UEs which obtain the UE ID can correctly receive the data service information, and the interference randomizing effect of the sending of the signal is improved and the interference with the system is reduced.

### Embodiment 6

As predefined by a system, D2D UE may determine a type of an initial value used in a corresponding signal processing according to target users of a signal to be sent. For example,

if a target user of the signal to be sent is an independent D2D UE, the sending UE uses a UE ID as an initial value for generating a cyclic shift sequence, thus the data transmission security of D2D UE is improved, a designated target receiving user can correctly receive the data service information, and the interference randomizing effect of the sending of the signal is improved and the interference with the system is reduced;

if the signal to be sent is a broadcast signal, target users are all D2D UEs around the sending UE, the sending UE uses a constant value as an initial value for generating a cyclic shift sequence, other D2D UEs around the sending UE can receive the control information without other information, further processing can be performed according to the obtained control information, it is beneficial to improve the data receiving efficiency of a D2D communication network; and

if the signal to be sent is a multicast signal, target users are all D2D UEs in the group, sending UE uses a Group ID as an initial value for generating a cyclic shift sequence, the data transmission security is guaranteed through the security restriction of the Group ID, and due to different Group IDs between groups, the interference randomizing effect of the sending of the signal is improved and the interference with the system is reduced.

### Embodiment 7

When sending D2D control information, UE may process a signal by adopting PUCCH and thus a cyclic shift sequence n_{cs}^{cell}(nₛ,l) needs to be used:

n_{cs}^{cell}(nₛl)=Σᵢ₌₀⁷c(8N_{symb}^{UL}·nₛ+8l+i)·2ⁱ

wherein,

c(i) is a pseudo-random sequence and is generated by a Gold sequence with the length of 31:

c(n)=(x₁(n+1N_{C})+x₂(n+N_{C}))mod 2

x₁(n+31)=(x₁(n+3)+x₁(n))mod 2

x₂(n+31)=(x₂(n+3)+x₂(n+2)+x₂(n+1)+x₂(n))mod 2

wherein, N_{C}=1600, initial values of two m sequences are respectively:

x₁(0)=1,x₁(n)=0,n=1,2, . . . ,30,

initial value of x₂(n) is cᵢₙᵢₜ=Σᵢ₌₀³⁰x₂(i)·2ⁱ

Here, as predefined by a system, UE performs initialization on a cyclic shift sequence by adopting a fixed value “187”, a specific assignment way is cᵢₙᵢₜ=187, and the UE uses a constant value as an initial value according to the generation relation to obtain the cyclic shift sequence, processes the signal and then sends the signal.

### Embodiment 8

When sending D2D control information, UE may adopt PUSCH to carry and send information, and scrambling processing needs to be performed on information output after coding:

\tilde{b}(i)=(b(i)+c(i))mod 2 _{(i)=(b(i)}

wherein a generation mode of a scrambling sequence c(i) is as described in embodiment 7.

Here, the UE uses a UE ID as an initial value for generating a sequence, a specific assignment way is cᵢₙᵢₜ=UE ID, and the UE uses the UE ID as an initial value according to the generation relation to obtain a scrambling sequence, processes the signal and then sends the signal.

### Embodiment 9

When sending D2D control information, UE may adopt PUCCH format 3 to carry and send information, and scrambling processing needs to be performed on information output after coding:

\tilde{b}(i)=(b(i)+c(i))mod 2_{(i)=(b(i)+c(i)mod 2}

wherein a generation mode of a scrambling sequence c(i) is as described in embodiment 7.

Here, the UE uses a UE ID and a Group ID jointly as an initial value for generating a sequence, comprehensive initialization assignment is performed on an m sequence, a specific assignment way is cᵢₙᵢₜ=Group ID·2¹⁶+UE ID, and the UE uses the UE ID and the Group ID as an initial value according to the generation relation to obtain a scrambling sequence, processes the signal and then sends the signal.

### Embodiment 10

UE uses PUCCH format 2 to carry D2D control information, and in a signal processing, cyclic shift expansion needs to be performed on modulated symbols:

$$\begin{matrix}{z}^{( \tilde{p} )} ( {N}_{seq}^{PUCCH} \cdot n + i ) = \frac{1}{\sqrt{P}} d ( n ) \cdot {r}_{u , v}^{( {α}_{\tilde{p}} )} ( i ) \\ n = 0 , 1 , … , 9 \\ i = 0 , 1 , … , {N}_{sc}^{RB} - 1\end{matrix}$$

wherein a cyclic shift expansion sequence r_{u,v}^{(α)}(n)=e^{jαn}r̅_{u,v}(n), and in a fundamental sequence r̅_{u,v}(n), a fundamental sequence group number u=(f_{gh}+fₛₛ)mod 30,

wherein f_{gh} is determined by a pseudo-random sequence c(i), here, as predefined by a system, the UE uses a constant value as an initial value for generating c(i), a specific assignment way is cᵢₙᵢₜ=255; fₛₛ^{PUCCH}=UE ID mod 30 and the UE uses a constant value in combination with the UE ID as an initial value to jointly determine the fundament sequence group number u, further obtains a cyclic shift sequence, processes the signal and then sends the signal.

### Embodiment 11

When sending D2D data information, UE may adopt PUSCH to carry and send information, and scrambling processing needs to be performed on information output after coding:

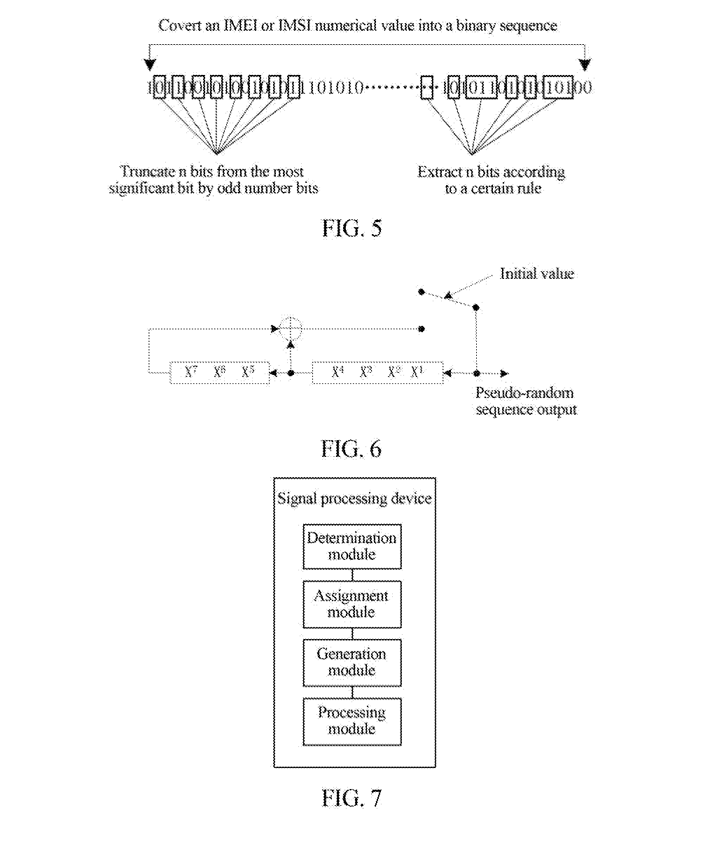

(i)=(b(i)+c(i)mod^{\tilde{b}(i)=(b(i)+c(i))mod 2}

wherein a scrambling sequence c(i) is generated by a shift register illustrated in FIG. 6.

Here, the UE adopts UE ID as an initial value of the shift register according to a predefined rule, the type of the UE ID is RNTI, low 7 bits in RNTI are used as an initial value to generate an m sequence, and further scrambling processing is performed on data by using the generated sequence c(i).

### Embodiment 12

When sending D2D data information, UE may adopt PUSCH to carry and send information, and scrambling processing needs to be performed on information output after coding:

\tilde{b}(i)=(b(i)+c(i))mod 2_{i=(b(i)+c(i)mod 2}

wherein a generation mode of a scrambling sequence c(i) is as described in embodiment 7.

Here, the UE uses a UE ID and a slot number nₛ jointly as an initial value for generating a sequence, comprehensive initialization assignment is performed on an m sequence, a specific assignment way is cᵢₙᵢₜ=(└nₛ/2┘+1)·2¹⁶+UE ID, and the UE uses the UE ID and the slot number as an initial value according to the above generation relation to obtain a scrambling sequence, processes the signal and then sends the signal.

### Embodiment 13

When sending D2D multicast data information, UE may adopt PUSCH to carry and send information, and scrambling processing needs to be performed on information output after coding:

(i)=(b(i)+c(i)mod 2^{\tilde{b}(i)=(b(i)+c(i))mod 2}

wherein a generation mode of a scrambling sequence c(i) is as described in embodiment 7.

Here, the UE uses a UE ID, a slot number nₛ and a Group ID jointly as an initial value for generating a sequence, comprehensive initialization assignment is performed on an m sequence, a specific assignment way is cᵢₙᵢₜ=Group ID·2²⁰+(└nₛ/2┘+1)·2¹⁶+UE ID, and the UE uses the UE ID, the Group ID and the slot number as an initial value according to the generation relation to obtain a scrambling sequence, processes the signal and then sends the signal.

### Embodiment 14

UE uses PUCCH format 2 to carry D2D control information, and in a signal processing, cyclic shift expansion needs to be performed on modulated symbols:

$$\begin{matrix}{z}^{( \tilde{p} )} ( {N}_{seq}^{PUCCH} \cdot n + i ) = \frac{1}{\sqrt{P}} d ( n ) \cdot {r}_{u , v}^{( {α}_{\tilde{p}} )} ( i ) \\ n = 0 , 1 , … , 9 \\ i = 0 , 1 , … , {N}_{sc}^{RB} - 1\end{matrix}$$

wherein a cyclic shift expansion sequence r_{u,v}^{(α)}(n)=e^{jαn}r̅_{u,v}(n), and in a fundamental sequence r̅_{u,v}(n), a fundamental sequence group number u=(f_{gh} (nₛ)+fₛₛ)mod 30

Wherein f_{gh}(nₛ) is determined by a pseudo-random sequence c(i). Here, as predefined by a system, the UE uses a slot number as an initial value for generating c(i), a specific assignment way is cᵢₙᵢₜ=└nₛ/2┘; fₛₛ PUCCH=i mod 30, wherein i is an index number of a PUCCH format 2 channel used by the UE, and the UE uses a slot number and a channel resource index number jointly as an initial value to determine the fundament sequence group number u, further obtains a cyclic shift sequence, processes the signal and then sends the signal.

FIG. 7 is a schematic diagram of a signal processing device according to the embodiment of the present invention. As illustrated in FIG. 7, the signal processing device provided by the embodiment comprises:

a determination module used to, when there are data to be sent, determine a generation mode of a pseudo-random sequence according to a type of the data to be sent;

an assignment module used to, when the type of the data to be sent is device-to-device communication data, assign a value to an initial value for generating the pseudo-random sequence according to a predefined rule;

a generation module used to generate the pseudo-random sequence according to the initial value; and generate a scrambling sequence, a cyclic shift sequence and a pilot sequence according to the pseudo-random sequence; and

a processing module used to process the data to be sent by using the scrambling sequence, the cyclic shift sequence and the pilot sequence.

Herein, the assignment module assigns a value to the initial value for generating the pseudo-random sequence by using one or more of the following: constant value, user equipment identification, group identification, frame number, subframe number, slot number, codeword number, antenna port number or resource index, wherein,

the user equipment identification is an identification number of the user equipment in a device-to-device communication network; and the group identification is an identification of a device-to-device communication group to which the user equipment belongs.

In a preferred embodiment, the user equipment identification used for assignment by the assignment module comprises:

a radio network temporary identifier, or

an international mobile equipment identity of the user equipment, or

an international mobile subscriber identification of the user equipment, or

a truncated international mobile equipment identity or a truncated international mobile subscriber identification, wherein the length of the truncated international mobile equipment identity or the truncated international mobile subscriber identification is n bits and n is a positive integer less than or equal to 16, or

an identification with the length of k, wherein k is a positive integer less than 16, and

the truncated international mobile equipment identity or the truncated international mobile subscriber identification comprises:

selecting n bits from a numerical value corresponding to the international mobile equipment identity or the international mobile subscriber identification, wherein the selected n bits are continuous n bits starting from the most significant bit, or continuous n bits starting from the least significant bit, or continuous or discontinuous n bits at designated positions, or

performing a modulo-N operation on the numerical value corresponding to the international mobile equipment identity or the international mobile subscriber identification, wherein N=2ⁿ.

In a preferred embodiment, the assignment module may be used to assign a value to the initial value for generating the pseudo-random sequence by using a fixed initial value; or determine to use the initial value according to one or more of the following: attribute of a signal to be sent, target user attribute, signal sending mode, signal transmission mode, and attribute of a resource for carrying the signal.

In a preferred embodiment, the assignment module assigns a value to the initial value for generating the pseudo-random sequence by using the fixed initial value, which may include at least one of the following: the user equipment assigns a value to the initial value of the pseudo-random sequence by using the constant value; the user equipment assigns a value to the initial value of the pseudo-random sequence by using the user equipment identification; the user equipment assigns a value to the initial value of the pseudo-random sequence by using the user equipment identification and the group identification; and the user equipment assigns a value to the initial value of the pseudo-random sequence by using the user equipment identification and the slot number.

In a preferred embodiment, the assignment module determines to use the initial value according to one or more of the following: the attribute of the signal to be sent, the target user attribute, the signal sending mode, the signal transmission mode, and the attribute of the resource for carrying the signal, which may include at least one of the following: when the attribute of the signal to be sent is control information or the attribute of the resource for carrying the signal is control channel resource, the user equipment assigns a value to the initial value of the pseudo-random sequence by using the user equipment identification and/or the constant value; when a service type of the signal to be sent is data information or the attribute of the resource for carrying the signal is data channel resource, the user equipment assigns a value to the initial value of the pseudo-random sequence by using the user equipment identification or the group identification; when a target user of the signal to be sent is a specific user, or a transmission mode is unicast or the attribute of the resource for carrying the signal is unicast channel resource, the user equipment assigns a value to the initial value of the pseudo-random sequence by using the user equipment identification; when target users of the signal to be sent are a specific group of users, or the transmission mode is multicast or the attribute of the resource for carrying the signal is multicast channel resource, the user equipment assigns a value to the initial value of the pseudo-random sequence by using the user equipment identification and/or the group identification; when target users of the signal to be sent are all other users, or the transmission mode is broadcast or the attribute of the resource for carrying the signal is broadcast channel resource, the user equipment assigns a value to the initial value of the pseudo-random sequence by using the user equipment identification and/or the constant value; when a single-antenna sending mode is adopted for the signal to be sent, the user equipment assigns a value to the initial value of the pseudo-random sequence by using one or more of the constant value, the user equipment identification and the slot number; and when a multi-antenna sending mode is adopted for the signal to be sent, the user equipment assigns a value to the initial value of the pseudo-random sequence by using the user equipment identification and/or the antenna port number.

In a preferred embodiment, the generation module generates the pseudo-random sequence according to the initial value, which may include: the initial value is used for the assignment of an initial value of an m sequence for generating the pseudo-random sequence, and assignment is performed on initial 31 bits of the m sequence; and the pseudo-random sequence is obtained based on the m sequence.

In a preferred embodiment, the generation module generates the pseudo-random sequence according to the initial value, which may include: the initial value is used as an initial value of a shift register; and the pseudo-random sequence is obtained based on a characteristic equation of the m sequence determined through the shift register.

In a preferred embodiment, the generation module generates one or more of the scrambling sequence, the cyclic shift sequence and the pilot sequence according to the pseudo-random sequence, which includes: the pseudo-random sequence is used as the scrambling sequence; or the pseudo-random sequence is used as the cyclic shift sequence, or a fundamental sequence of the cyclic shift sequence is obtained according to the pseudo-random sequence; or a fundamental sequence of the pilot sequence is obtained according to the pseudo-random sequence; and

the processing module processes the data to be sent by using one or more of the scrambling sequence, the cyclic shift sequence and the pilot sequence, which includes: scrambling processing is performed on the data to be sent by using the scrambling sequence; or cyclic shift processing is performed on the data to be sent by using the cyclic shift sequence; or the pilot sequence is used as pilot in the sending of the data to be sent.

The embodiment of the present invention further provides a user equipment, comprising the above-mentioned information processing device.

One skilled in the art can understand that all or partial steps in the above-mentioned method can be completed by relevant hardware instructed by a program, and the program can be stored in a computer readable storage medium such as a read only memory, a magnetic disk or an optical disk, etc. Alternatively, all or partial steps of the above-mentioned embodiments can also be implemented by using one or more integrated circuits. Correspondingly, each module/unit in the above-mentioned embodiments can be implemented by means of hardware, and can also be implemented by means of a software function module. The present invention is not limited to combinations of hardware and software in any specific form.

The embodiments are just preferred embodiments of the present invention. Of course, the present invention may further have other various embodiments. One skilled in the art can make various corresponding modifications and variations according to the present invention without departing from the rule and essence of the present invention. However, all these corresponding modifications and variations shall also fall into the protection range of the attached claims of the present invention.

### INDUSTRIAL APPLICABILITY

The embodiments of the present invention provide a signal processing method and device, such that UE can generate a pseudo-random sequence by using a predefined initial value type as an initialization parameter, and perform processing such as scrambling, cyclic shift, pilot insertion on signals to be sent, so as to play roles of randomizing the signal interference, enhancing the anti-interference capability, and improving the signal receiving correction rate and the resource utilization rate.

1. A signal processing method, comprising:
when there are data to be sent at user equipment, the user equipment determining a generation mode of a pseudo-random sequence according to a type of the data to be sent;
When the type of the data to be sent is device-to-device communication data, the user equipment assigning a value to an initial value for generating the pseudo-random sequence according to a predefined rule, and
the user equipment generating the pseudo-random sequence according to the initial value; generating one or more of a scrambling sequence, a cyclic shift sequence and a pilot sequence according to the pseudo-random sequence; and
processing the data to be sent by using one or more of the scrambling sequence, the cyclic shift sequence and the pilot sequence.

2. The method according to claim 1, wherein a value is assigned to the initial value for generating the pseudo-random sequence by using one or more of the following: constant value, user equipment identification, group identification, frame number, subframe number, slot number, codeword number, antenna port number and resource index, wherein,
the user equipment identification is an identification number of the user equipment in a device-to-device communication network; and the group identification is an identification of a device-to-device communication group to which the user equipment belongs.

3. The method according to claim 2, wherein the user equipment identification comprises:
a radio network temporary identifier, or
an international mobile equipment identity of the user equipment, or
an international mobile subscriber identification of the user equipment, or
a truncated international mobile equipment identity or a truncated international mobile subscriber identification, wherein a length of the truncated international mobile equipment identity or the truncated international mobile subscriber identification is n bits and n is a positive integer less than or equal to 16, or
an identification with a length of k, wherein k is a positive integer less than 16.

4. The method according to claim 3, wherein the truncated international mobile equipment identity or the truncated international mobile subscriber identification comprises:
selecting n bits from a numerical value corresponding to the international mobile equipment identity or the international mobile subscriber identification, wherein the selected n bits are continuous n bits starting from a most significant bit, or continuous n bits starting from a least significant bit, or continuous or discontinuous n bits at designated positions, or
performing a modulo-N operation on the numerical value corresponding to the international mobile equipment identity or the international mobile subscriber identification, wherein N=2ⁿ.

5. The method according to claim 1, wherein the user equipment assigning a value to an initial value for generating the pseudo-random sequence according to a predefined rule comprises:
the user equipment assigning a value to the initial value for generating the pseudo-random sequence by using a fixed initial value; or
the user equipment determining to use the initial value according to one or more of the following:
attribute of a signal to be sent, target user attribute, signal sending mode, signal transmission mode, and attribute of a resource for carrying the signal.

6. The method according to claim 5, wherein the user equipment assigning a value to the initial value for generating the pseudo-random sequence by using a fixed initial value comprises at least one of the following:
the user equipment assigning a value to the initial value of the pseudo-random sequence by using a constant value;
the user equipment assigning a value to the initial value of the pseudo-random sequence by using a user equipment identification;
the user equipment assigning a value to the initial value of the pseudo-random sequence by using a user equipment identification and a group identification; and
the user equipment assigning a value to the initial value of the pseudo-random sequence by using a user equipment identification and a slot number.

7. The method according to claim 5, wherein the user equipment determining to use the initial value according to one or more of the following: attribute of a signal to be sent, target user attribute, signal sending mode, signal transmission mode, and attribute of a resource for carrying the signal, comprises at least one of the following:
when the attribute of the signal to be sent is control information or the attribute of the resource for carrying the signal is control channel resource, the user equipment assigning a value to the initial value of the pseudo-random sequence by using a user equipment identification and/or a constant value;
when a service type of the signal to be sent is data information or the attribute of the resource for carrying the signal is data channel resource, the user equipment assigning a value to the initial value of the pseudo-random sequence by using a user equipment identification or a group identification;
when the target user of the signal to be sent is a specific user, or the transmission mode is unicast, or the attribute of the resource for carrying the signal is unicast channel resource, the user equipment assigning a value to the initial value of the pseudo-random sequence by using a user equipment identification;
when target users of the signal to be sent are a specific group of users, or the transmission mode is multicast or the attribute of the resource for carrying the signal is multicast channel resource, the user equipment assigning a value to the initial value of the pseudo-random sequence by using a user equipment identification and/or a group identification;
when target users of the signal to be sent are all other users, or the transmission mode is broadcast or the attribute of the resource for carrying the signal is broadcast channel resource, the user equipment assigning a value to the initial value of the pseudo-random sequence by using a user equipment identification and/or a constant value;
when a single-antenna sending mode is adopted for the signal to be sent, the user equipment assigning a value to the initial value of the pseudo-random sequence by using any one or more of a constant value, a user equipment identification and a slot number; and
when a multi-antenna sending mode is adopted for the signal to be sent, the user equipment assigning a value to the initial value of the pseudo-random sequence by using a user equipment identification and/or an antenna port number.

8. The method according to claim 1, wherein the user equipment generating the pseudo-random sequence according to the initial value comprises:
using the initial value for assigning a value to an initial value of an m sequence for generating the pseudo-random sequence, and assigning values to initial 31 bits of the m sequence; and
obtaining the pseudo-random sequence based on the m sequence.

9. The method according to claim 1, wherein the user equipment generating the pseudo-random sequence according to the initial value comprises:
using the initial value as an initial value of a shift register; and
obtaining the pseudo-random sequence based on a characteristic equation of the m sequence determined through the shift register.

10. The method according to claim 1, wherein,
the user equipment generating one or more of a scrambling sequence, a cyclic shift sequence and a pilot sequence according to the pseudo-random sequence comprises:
using the pseudo-random sequence as the scrambling sequence; or
using the pseudo-random sequence as the cyclic shift sequence, or obtaining a fundamental sequence of the cyclic shift sequence according to the pseudo-random sequence; or
obtaining a fundamental sequence of the pilot sequence according to the pseudo-random sequence; and
the user equipment processing the data to be sent by using one or more of the scrambling sequence, the cyclic shift sequence and the pilot sequence comprises:
performing scrambling processing on the data to be sent by using the scrambling sequence; or
performing cyclic shift processing on the data to be sent by using the cyclic shift sequence; or
using the pilot sequence as a pilot of the sending of the data to be sent.

11. A signal processing device, comprising:
a determination module configured to, when there are data to be sent, determine a generation mode of a pseudo-random sequence according to a type of the data to be sent;
an assignment module configured to, when the type of the data to be sent is device-to-device communication data, assign a value to an initial value for generating the pseudo-random sequence according to a predefined rule;
a generation module configured to generate the pseudo-random sequence according to the initial value; and generate one or more of a scrambling sequence, a cyclic shift sequence and a pilot sequence according to the pseudo-random sequence; and
a processing module configured to process the data to be sent by using one or more of the scrambling sequence, the cyclic shift sequence and the pilot sequence.

12. The device according to claim 11, wherein the assignment module is configured to assign a value to the initial value for generating the pseudo-random sequence by using one or more of the following: constant value, user equipment identification, group identification, frame number, subframe number, slot number, codeword number, antenna port number and resource index, wherein,
the user equipment identification is an identification number of the user equipment in a device-to-device communication network; and the group identification is an identification of a device-to-device communication group to which the user equipment belongs.

13. The device according to claim 12, wherein the user equipment identification used for assignment by the assignment module comprises:
a radio network temporary identifier, or
an international mobile equipment identity of the user equipment, or
an international mobile subscriber identification of the user equipment, or
a truncated international mobile equipment identity or a truncated international mobile subscriber identification, wherein a length of the truncated international mobile equipment identity or the truncated international mobile subscriber identification is n bits and n is a positive integer less than or equal to 16, or
an identification with a length of k, wherein k is a positive integer less than 16, and
the truncated international mobile equipment identity or the truncated international mobile subscriber identification comprises:
selecting n bits from a numerical value corresponding to the international mobile equipment identity or the international mobile subscriber identification, wherein the selected n bits are continuous n bits starting from a most significant bit, or continuous n bits starting from a least significant bit, or continuous or discontinuous n bits at designated positions, or
performing a modulo-N operation on the numerical value corresponding to the international mobile equipment identity or the international mobile subscriber identification, wherein N=2ⁿ.

14. The device according to claim 11, wherein,
the assignment module is configured to assign a value to the initial value for generating the pseudo-random sequence by using a fixed initial value; or
determine to use the initial value according to one or more of the following: attribute of a signal to be sent, target user attribute, signal sending mode, signal transmission mode, and attribute of a resource for carrying the signal.

15. The device according to claim 14, wherein the assignment module being configured to assign a value to the initial value for generating the pseudo-random sequence by using a fixed initial value, comprises at least one of the following:
the user equipment assigning a value to the initial value of the pseudo-random sequence by using a constant value;
the user equipment assigning a value to the initial value of the pseudo-random sequence by using a user equipment identification;
the user equipment assigning a value to the initial value of the pseudo-random sequence by using a user equipment identification and a group identification;
and the user equipment assigning a value to the initial value of the pseudo-random sequence by using a user equipment identification and a slot number.

16. The device according to claim 14, wherein,
the assignment module being configured to determine to use the initial value according to one or more of the following: attribute of a signal to be sent, target user attribute, signal sending mode, signal transmission mode, and attribute of a resource for carrying the signal, comprises at least one of the following:
when the attribute of the signal to be sent is control information or the attribute of the resource for carrying the signal is control channel resource, the user equipment assigning a value to the initial value of the pseudo-random sequence by using a user equipment identification and/or a constant value;
when a service type of the signal to be sent is data information or the attribute of the resource for carrying the signal is data channel resource, the user equipment assigning a value to the initial value of the pseudo-random sequence by using a user equipment identification or a group identification;
when the target user of the signal to be sent is a specific user, or the transmission mode is unicast, or the attribute of the resource for carrying the signal is unicast channel resource, the user equipment assigning a value to the initial value of the pseudo-random sequence by using a user equipment identification;
when target users of the signal to be sent are a specific group of users, or the transmission mode is multicast or the attribute of the resource for carrying the signal is multicast channel resource, the user equipment assigning a value to the initial value of the pseudo-random sequence by using a user equipment identification and/or a group identification;
when target users of the signal to be sent are all other users, or the transmission mode is broadcast or the attribute of the resource for carrying the signal is broadcast channel resource, the user equipment assigning a value to the initial value of the pseudo-random sequence by using a user equipment identification and/or a constant value;
when a single-antenna sending mode is adopted for the signal to be sent, the user equipment assigning a value to the initial value of the pseudo-random sequence by using any one or more of a constant value, a user equipment identification and a slot number; and when a multi-antenna sending mode is adopted for the signal to be sent, the user equipment assigning a value to the initial value of the pseudo-random sequence by using a user equipment identification and/or an antenna port number.

17. The device according to claim 11, wherein,
the generation module being configured to generate the pseudo-random sequence according to the initial value, comprises:
using the initial value for assigning a value to an initial value of an m sequence for generating the pseudo-random sequence, and assigning values to initial 31 bits of the m sequence; and
obtaining the pseudo-random sequence based on the m sequence.

18. The device according to claim 11, wherein the generation module being configured to generate the pseudo-random sequence according to the initial value, comprises:
using the initial value as an initial value of a shift register; and
obtaining the pseudo-random sequence based on a characteristic equation of the m sequence determined through the shift register.

19. The device according to claim 11, wherein,
the generation module being configured to generate one or more of a scrambling sequence, a cyclic shift sequence and a pilot sequence according to the pseudo-random sequence, comprises:
using the pseudo-random sequence as the scrambling sequence; or
using the pseudo-random sequence as the cyclic shift sequence, or
obtaining a fundamental sequence of the cyclic shift sequence according to the pseudo-random sequence; or obtaining a fundamental sequence of the pilot sequence according to the pseudo-random sequence; and
the processing module being configured to process the data to be sent by using one or more of the scrambling sequence, the cyclic shift sequence and the pilot sequence, comprises:
performing scrambling processing on the data to be sent by using the scrambling sequence; or
performing cyclic shift processing on the data to be sent by using the cyclic shift sequence; or
using the pilot sequence as a pilot of the sending of the data to be sent.

20. A user equipment, comprising the device according to claim 11.
